(19) United States
(12) Patent Application Publication
(10) Pub. No.: US 2002/0095383 A1
(43) Pub. Date: Jul. 18, 2002

(54) Method and apparatus for secure sale of electronic tickets

(75) Inventors: Catherine Mengin, La Varenne (FR); Marco Martens, Chappaqua, NY (US); Howard Edward Sachar, Mt. Kisco, NY (US); Charles Philippe Tresser, Mamaroneck, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/098,453

(22) Filed: Mar. 18, 2002

Related U.S. Application Data
(62) Division of application No. 09/398,029, filed on Sep. 17, 1999.

(51) Int. Cl. G06F 17/60

(52) U.S. Cl. 705/50

(57) ABSTRACT

A method (and apparatus) for guaranteeing authenticity of an object, includes providing a sample of material obtainable only by at least one of chemical and physical processes such that the sample is random and not reproducible, associating a number reproducibly to the sample by using a specific reader, and forming at least one coded version of the number. The at least one coded version is obtained by a public key encryption, and the version is recorded into an area of the object.

### BACKGROUND OF THE INVENTION

1. Field of the Invention

The present invention generally relates to a problem of remotely selling tickets, such that the buyer can print a ticket, and yet false or fraudulent tickets are very hard, if not impossible to produce.

2. Description of the Related Art

Recently, electronic commerce (e.g. so-called “e-commerce”) of goods and services has increased dramatically. However, a problem which has inhibited many potential consumers from fully participating in e-commerce has been the fear that such commerce is not secure. That is, the transactions are not believed to be secure and in some cases it is believed that payment schemes (e.g., credit card, passwords, personal identification numbers (PINs), account numbers, etc.) may be compromised.

Further, some potential consumers may deem that the goods and services being offered are not legitimate.

For example, in some cases, a merchant M (e.g., such as travel agency/airline ticket offices, box offices, retail ticket offices such as “Ticketron”, etc., can remotely sell to customers C1, C2, . . . , tickets, such as theater tickets, land, sea, or air transportation tickets, sporting event tickets, and so on. Upon authorization of payment, the tickets are usually mailed or available for pickup at the ticket event. This is inconvenient in that the merchant must print the ticket, mail the ticket, etc. and the customer must pick them up at a future date. There is no immediate access to the ticket by the customer.

That is, currently there is no facility for the customer to print the ticket so that the legitimate tickets will not be repudiated, etc.

Further, counterfeiting is a problem. That is, it is very easy to create false tickets which are mistaken for original tickets, especially by unskilled ticket-takers typically taking tickets in crowded, confusing venues.

Moreover, absent a reliable accounting system, at times multiple issues of a legitimate ticket may occur even though such multiple issues do not authorize multiple use of the ticket.

Yet another problem is “scalping” of tickets. Scalping occurs when a block of tickets is purchased by a speculator at normal prices, and then sold to a customer for higher than face value. Scalping is prohibited under many laws. Thus, currently there is no mechanism to resell (or return) a ticket if some event (e.g., health, inconvenience, etc.) prevents its use by the original buyer.

### SUMMARY OF THE INVENTION

In view of the foregoing and other problems of the conventional methods and systems, an object of the present invention is to provide a method and system which increases the reliability of and confidence in electronic commerce and especially that involving the printing and sale of tickets.

Another object is to inhibit counterfeiting of tickets.

A further object is to allow a customer to print a ticket after the customer has paid for the ticket and has been authorized to print by a merchant.

Yet another object is to provide a method and system in which a merchant M and a customer C both have access to a computer, the customer furthermore has access to a digital printer (or a more sophisticated machine), and the merchant communicates to the customer a precise description of what has to be printed to constitute a ticket.

Another object is to provide a mechanism and method for reliably preventing multiple uses of a legitimate ticket based on multiple issues of the same.

Yet another object is to provide a mechanism for legitimately reselling a ticket to the merchant or otherwise, if some predetermined event (e.g., health, inconvenience, etc.) occurs.

In a first aspect of the present invention, a method of remotely printing an object by a customer, includes contacting, by a customer, a merchant of the object, prompting, by the merchant, the customer for information related to the object, composing, by the merchant, a digital message based on the information provided by the customer, encrypting the digital message, sending the encrypted digital message to the customer, and selectively printing, by the customer, the digital message as the object.

A second aspect of the present invention uses a method (and system) of guaranteeing authenticity of an object which either uses smart cards or uses what is described in U.S. patent application Ser. No. 09/___,___, filed on ______, commonly assigned and entitled “METHOD AND APPARATUS FOR PRODUCING DUPLICATION- AND IMITATION-RESISTANT IDENTIFYING MARKS ON OBJECTS, AND DUPLICATION- AND IMITATION-RESISTANT OBJECTS”, having IBM Docket YO999-129 and incorporated herein by reference in its entirety. The invention in YO999-129 includes providing a sample of material obtainable only by at least one of chemical and physical processes (e.g., the paper contains random inclusions of optical and/or magnetic markers, or a sample of material, such as a variety of minerals such as rocks and for some glasses which are suddenly quenched from high temperatures or from the melt, and subsequently covered with diamond-like carbon film, and is then attached to the paper) such that the sample is random and not reproducible, associating a number reproducibly with the sample, using a specific reader, associating at least one coded version of the number, the at least one coded version being obtained by a public key encryption, and the coded version being recorded into an area of the object.

Using paper containing a smart card or prepared according to the teaching of the above mentioned U.S. patent application Ser. No. 09/___,___, having IBM Docket No. YO999-129, one can remotely print documents so that the party that controls the printer and/or the computer or more general driver of the printer, cannot print further copies of the document which could be presented as original without means of identification.

This is achieved by linking the random number uniquely associated to the sample of paper where the document is to be printed or a number hidden in the smart card, to the content of the document itself, and printing, together with the document, a coded version of the combination, preferably using public key cryptography. Related art is also described in the invention in U.S. U.S. patent application Ser. No. 09/___,___, filed on ______, commonly assigned and entitled “METHOD AND SYSTEM FOR REMOTE PRINTING OF DUPLICATION RESISTANT DOCUMENTS”, and having IBM Docket No. YO999-290, incorporated herein in its entirety.

### BRIEF DESCRIPTION OF THE DRAWINGS

The foregoing and other purposes, aspects and advantages will be better understood from the following detailed description of preferred embodiments of the invention with reference to the drawings, in which:

FIG. 1 is a block diagram of an exemplary format for an object (e.g., ticket) printed according to a first preferred embodiment of the present invention;

FIG. 2A illustrates an upper level environment of a method and system according to the present invention;

FIG. 2B illustrates a flow diagram representing how the information needed to produce a ticket is processed;

FIG. 3 illustrates an exemplary information handling/computer system for use with the invention on the customer side and/or the merchant side; and

FIG. 4 illustrates a medium for storing a program for implementing the method according to the present invention.

### DETAILED DESCRIPTION OF PREFERRED EMBODIMENTS OF THE INVENTION

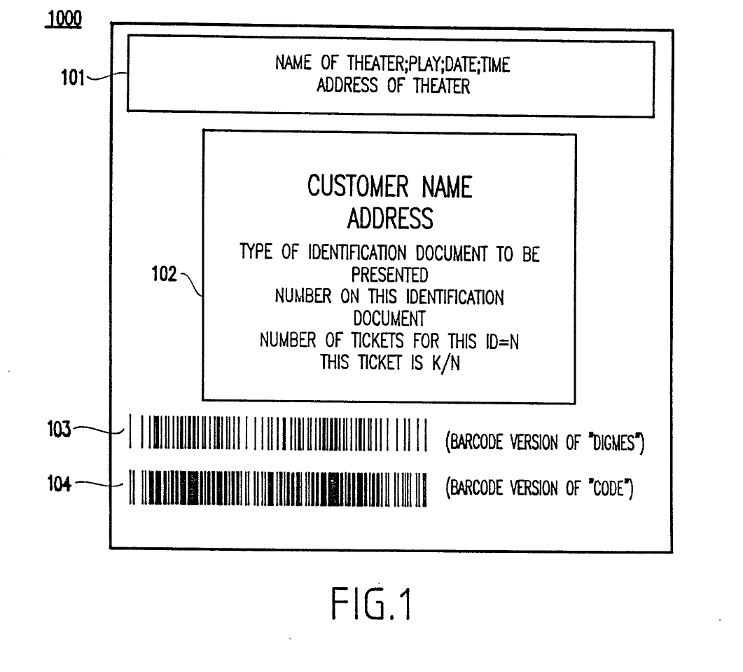

Referring now to the drawings, and more particularly to FIGS. 1-4, there are shown preferred embodiments of the method and structures according to the present invention.

Referring now to the drawings, and more particularly to FIG. 1, there is shown a block diagram of an object (e.g., a medium such as a ticket) 1000 printed according to a first preferred embodiment of the present invention.

As shown, the ticket 1000 may include an identification 101 of the performance for which it is performed including name and address of the venue, the performance, date and time. While not shown for brevity, other information could also be printed such as seat number, some special right conferred by the ticket (e.g., such as a free drink or food item), etc.

Further, the ticket 1000 includes an identification 102 of the user, including the user's name and address, the designation (e.g., type of identification document such as passport, driver's license, etc.) of the document which the customer will use to identify himself or herself to the ticket taker (who, in some instances, may be replaced by a machine), the total number N of tickets bought by the customer for the subject identification, and the order number of the ticket among all those forming this set.

Additionally, the ticket 1000 may include a bar-code presentation 103, 104 (discussed in further detail below) of the essential information, which can be easily and efficiently scanned by an automated mechanism such as a hand-held scanner, optical reader, or the like. Such essential information may include a “digital message” and/or a “code”.

Currently, there are many commercially-available light, hand-held scanners. Together with the fonts used on the ticket being determined by the vendor, such scanners/readers make using bar-codes optional but extremely convenient.

The coded version of the information can be presented as a human-readable number as well, in which case it would be easier to implement a simple rule (e.g., the last three digits of the number should for a number divisible by 8, there are no consecutive letters in the message, there is single pair of consecutive letter but they are separated by an “8”, etc.) which would recognize the most elementary counterfeit without using any technology.

Such information is presented from a purchaser to a merchant electronically (e.g., over the Internet, etc.) through a purchaser's computer to the merchant's computer. Alternatively, telephony could be used either additionally or alternatively to the Internet.

To ensure security, private key/public key pairs (also referred to as “public encryption schemes”) and secure hash functions (such as the Secure Hash Algorithm (SHA-1)) may be advantageously employed by the present invention.

The use of private key/public key pairs, of the Information Dispersal Algorithm (IDA), and of secure hash functions are well known. A description of these techniques and some of their implementations can be found in “Handbook of Applied Cryptography”, by Alfred J. Menezes, Paul C. van Oorschot and Scott A. Vanstone, CRC Press, 1997 and in “Cryptography, Theory and Practice” by Douglas R. Stinson, CRC Press, 1995.

For example, in an exemplary implementation, each time a private encryption scheme is used, one can choose the Rivest-Shamir-Adleman (RSA) protocol, described in U.S. Pat. No. 4,405,829, incorporated herein by reference, as a method to generate and use a SK/PK pair to allow for public encryption.

Additionally or alternatively to the above method, other methods could also be used (see, e.g., the above-mentioned “Handbook of Applied Cryptography”).

Further, the present invention may utilize several forms of secure methods of payment on the Internet and/or accepted methods of payment using telephony (e.g., such as Secure Socket Layer (SSL)-based payment systems or the use of SecureID as sold by Security Dynamics, Inc.) currently in use. This can be done using a bank or some other “payment partner” which may even be the merchant.

In the present invention, a merchant M can remotely sell to customers M1, M2, . . . , tickets ,such as theater tickets, land, sea, or air transportation tickets, sporting event tickets, and so on. Preferably, the customer can print the ticket at the customer's printer. With the method of the invention, legitimate tickets will not be repudiated, except possibly for a small minority, as in the case of any type of tickets.

Further, with the invention, it is difficult, if not impossible, to produce fraudulent tickets which could be mistaken for original tickets.

Moreover, some embodiments of the invention design further copies as fraudulent, while other embodiments allow for any further print to appear as authentic, and indistinguishable from the first print. In the later case, multiple issues of a legitimate ticket do not authorize multiple use whenever the ticket is intended for a single use (i.e., it is useless to copy a ticket, except to serve as a backup if the original is lost or destroyed).

Additionally, as described below, in the invention, the ticket may be resold if some event (e.g., health, inconvenience, etc.) prevents its use by the original buyer, if the party which sells the ticket decides such a possibility should be made available.

It is noted that the merchant does not need to communicate directly with the printing stations. As documents can be circulated securely between computers in electronic form, using well-established cryptographic means, the merchant can delegate the contact with printing stations to a dedicated agency or a plurality thereof. Such agencies can also function as entities for authenticating documents. The simultaneous use of several agencies allows using the Information Dispersal Algorithm (IDA) (as described for example in the “Handbook of Applied Cryptography”) so that collusion between several agencies is needed to forge documents.

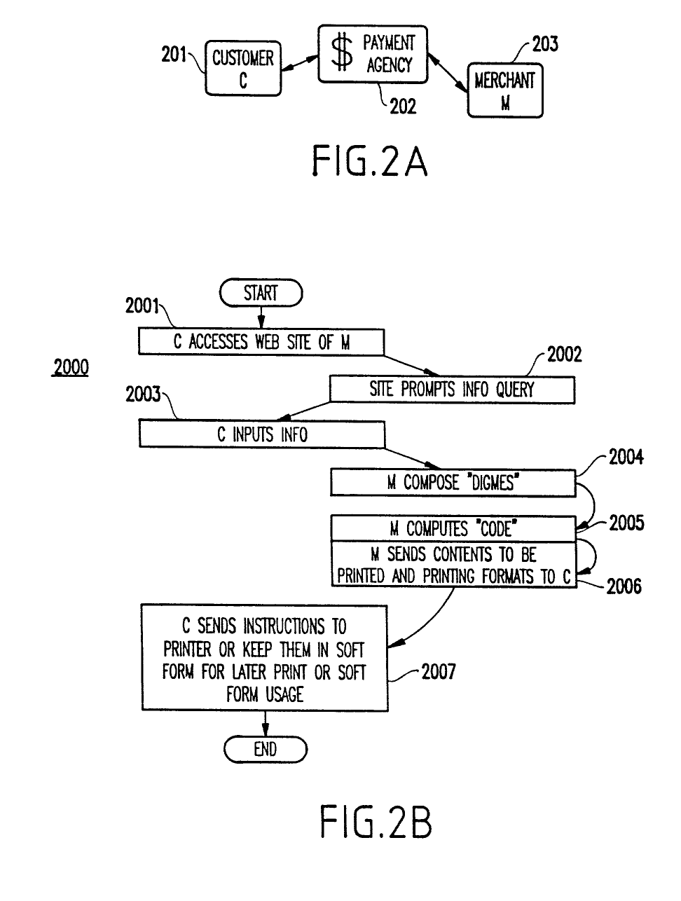

Turning to FIGS. 2A and 2B, an exemplary system environment and process flow according to the invention are shown.

As shown in FIG. 2A, a customer C 201, a payment agency 202, and a merchant M 203 are shown. Payment agency 202 may link the customer C 201 and the merchant M 203. Alternatively, the customer C could be linked directly to the merchant M, if the customer C has an account or similar arrangement with the merchant M.

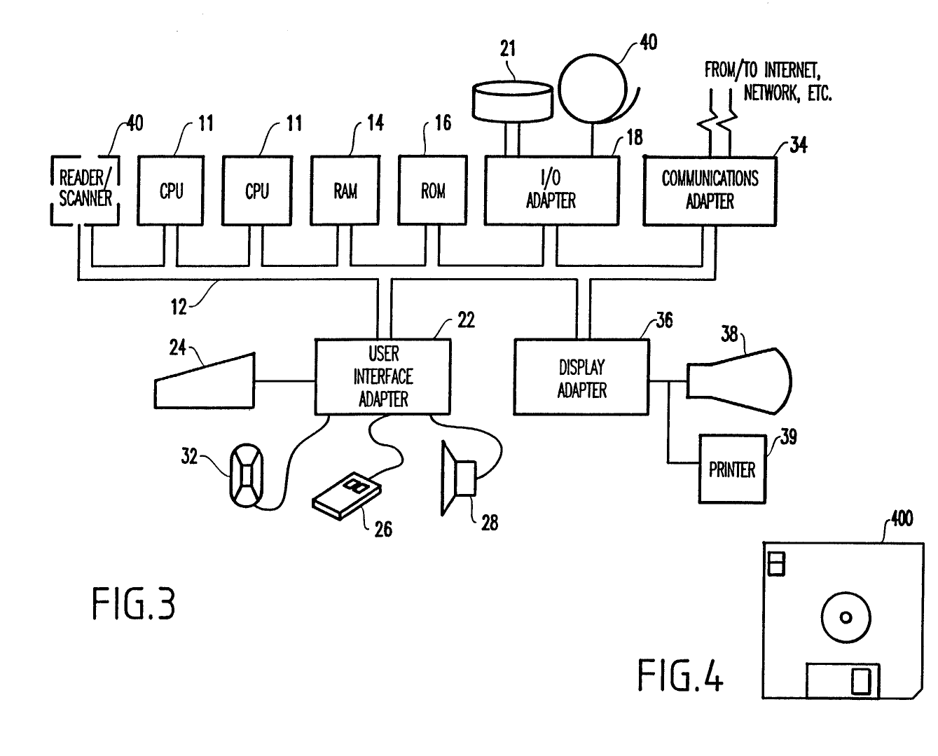

The merchant M and a customer C both have access to a computer having a processor, memory and the like. An exemplary, more detailed hardware configuration is shown in FIG. 3, and is discussed in further detail below.

Furthermore, the customer preferably has access to a digital printer (or a more sophisticated machine such as an offset printer). The merchant 203 communicates (via the Internet or any communication channel available between the merchant's computer and a driver (e.g., a computer) of the customer's printer) to the customer 201 a precise description of what must be printed to constitute a ticket.

For example, to begin the transaction, the customer may describe (e.g., using text the customer writes and/or checking out a list) the desired tickets.

Then, the customer C 201 gives her/his name “name” and the number N(C) of tickets to be bought under this name, or a list of such names and corresponding number of tickets.

This information, and some additional information which may include the name of the merchant, an inventory number(s), a number associated to peculiar personal identification documents (e.g., passport, driver's license, military identification card, etc.), biometrics data of the customer, etc., the characteristics of the printer used by the customer, etc. will be concatenated in a prescribed, constant order, with or without separating blocks (e.g., separating blocks is an optional type of formatting to allow easy recovery of the components of the information being concatenated) between the constituents of the complete message. This forms a long message called “message” in the sequel.

A typical, “message” can be reinterpreted digitally as a sequence of “0”s and “1”s, called a “digamas” (e.g., for “digital message”).

Then, the “digamas” is hashed. The hashing function can be selected trivially as the identity in contexts where the “digamas” is not too long, or a complicated function such as the secure hash function SHA-1. The hash function used in the process is denoted by H.

Then, the merchant 203 chooses a Private key/Public key pair (K, k). Such a selection may be made depending on the time of use (as a further element of security) and other parameters such as the type of ticket being ordered (which would be appropriate when the merchant sell tickets for various institution which each prefer to have their own key administration).

Then, the merchant M 203 composes the coded version of the hash of the “digamas”. That is, the “code”=K(H(“digamas”)). This “code” is a digital signature, while the bar-code is a support of information which can contain a representation of the plain text and/or of the “code”.

Then, the merchant M 203 is ready to forward to the customer C 201 the printing instructions.

The printing instructions may include an ordered list of all data which are relevant to the constitution of the “message”, together with precise fonts and format instructions (e.g., all together referred to as “LIST”). An example of a “LIST” is given by all information at 101 and 102 in FIG. 1, together with the format instruction such as position, the font to be used, and the format of various pieces of the text.

The printing instructions also may include the “code” defined previously, together with precise fonts and formats instructions to print this “code”.

Further, the printing instructions may include easily machine-readable versions (e.g., using bar-codes, bi-dimensional bar-codes, or the like) of “LIST” and/or “code”, together with precise fonts and formats instructions.

More precisely, “LIST” and “code” must each appear in at least one of the readable or easily machine readable forms, not necessarily in both. It is noted that since the fonts and format are imposed, automated character recognition (ACR) can be easily and stably implemented so that the plain text is machine-readable as well as the bar-codes, but with different equipment.

It is noted that using cryptography allows preventing tickets from being forged for other identifications, other events, etc. Printing several copies of a ticket for the same use for the same person is easy, but has no consequence other than offering a “backup” in case the customer loses the original ticket.

Thereafter, the customer C 201 prints the ticket on the customer's printer. As mentioned above, the ticket is readable by appropriate readers/scanners, using for example automatic character recognition (ACR), easily implemented as the fonts and format (and if needed, printer characteristics) are known, or bar-code readers, or a combination of such automated devices.

With current portable technology, a verification system for the ticket may include a hand-held reader and a small portable computer. The use of public cryptography when composing a “code” allows any party having access to the public part of the keys and the proper scanning equipment to control authenticity of the tickets without needing to be linked to a database, but such portable devices can communicate with a central computer and database if deemed preferable.

Also, if the ticket carries the name of the user, a control device can be used randomly. Thus, since electronic control is recognized to have high probability and reliability in counterfeit detection, ticket counterfeiting will be deterred, so long as the pattern of when control is exercised is not predictable.

The validity of the ticket is made by comparing the identity (and extra information as indicated above) displayed on the ticket to some documentation (and/or other form of identification such as biometrics) which may, for example, have a specific purpose and be machine-readable.

The present invention also may incorporate a mechanism for reimbursing the customer should the ticket not be usable by the customer due to health, inconvenience, etc., and may be offer for resale.

In such a case of ticket reimbursement (e.g., a so-called “ticket reimbursement option”), the automatic checking apparatus is linked to a database to refuse instances of a “code” which indicates that the tickets have been reimbursed and/or transferred. More precisely, each time a ticket is reimbursed, the “code” which was associated with the ticket at the time of sale is placed in a database of reimbursed tickets (e.g., the same database can also contain “codes” of stolen tickets and any other ticket to be refused). Each time someone tries to use a ticket, the ticket (and, in particular, the “code(s)”) is read and one controls if that “code” belong to the list to be refused. The database can either be consulted on-line or transferred to the portable control devices before the event when some sort of ticket is to be used.

It is noted that since tickets are very personal, it is unnecessary to keep track of tickets which have been used if no reimbursement option is offered, utilized or incorporated into the system of the present invention. However, such record-keeping may still be performed.

Also notice that the bearer would have to be prevented from exiting the venue after using the ticket. Alternatively, a central database maintained during the time of validity of the tickets, can be used to prevent the same identification card to be used several times for the same event.

Operational Flow

FIG. 2B is a flow diagram representing a method 2000 of processing the information for producing a ticket.

First, in step 2001 the customer C 201 contacts the merchant M at 203 by, for example, the Internet, possibly involving some payment agency 202. Alternatively or additionally, the customer could contact the merchant by telephony.

By the same token, if the customer C has an account with the merchant M, the payment agency need not be involved. The contact between the customer C and merchant M proceeds, for example, as follows.

First, in step 2001, to begin the process, the customer C accesses the Web site (e.g., domain address on the World-Wide-Web (WWW)) of the merchant M.

Through this web site, the merchant M prompts some information query (step 2002). As a result, in step 2003, the customer C 203 is allowed to choose a ticket, gift certificate, money order, certified check, or other sort of paper document carrying an intrinsic value and where the name of the user is usually printed.

After collecting all needed information, some of which may reside (e.g., pre-stored) in the customer profile (as for instance stored in a database at the merchant's computer) if the customer has an account with the merchant, the merchant M then composes the “digamas” (or digital message) (step 2004). As described above, the “digamas” is a symbolic representation of all information about the customer (e.g., name, or name and address), what the ticket or certificate authorizes (e.g., a fare, a meal, an exhibit, a performance, a cash value for a purchase, etc.), specifics about that performance such as date time and place, etc.

In step 2005, the “digamas” is transformed to its encrypted version. That is, the “digamas” is encrypted to produce “code”=K(H(“digamas”)) in a manner exemplarily described above.

Thereafter, in step 2006, the merchant M sends to the customer C all the needed printing instructions (including the content of all that needs to be printed) in the form of an electronic file being sent to the customer. Along these lines, a format including position of text to be printed, fonts, sizes of characters, possibly color, etc. (e.g., an exemplary output is presented in FIG. 1) of what is to be printed is sent along to the customer from the merchant M.

In step 2007, the customer may either print the ticket, etc. (e.g., a “hard copy”) or keep the same as a “soft copy” (software) for printing later.

As mentioned above, the configuration for the merchant and/or customer hardware configuration may take many forms, depending upon the designer's constraints ad requirements.

FIG. 3 illustrates a typical hardware configuration (e.g., for either or both of the merchant and customer) of an information handling/computer system in accordance with the invention preferably has at least one processor or central processing unit (CPU) 11.

The CPUs 11 are interconnected via a system bus 12 to a random access memory (RAM) 14, read-only memory (ROM) 16, input/output (I/O) adapter 18 (for connecting peripheral devices such as disk units 21 and tape drives 40 to the bus 12), user interface adapter 22 (for connecting a keyboard 24, mouse 26, speaker 28, microphone 32, and/or other user interface device to the bus 12), a communication adapter 34 for connecting an information handling system to a data processing network, the Internet, an Intranet, etc., and a display adapter 36 for connecting the bus 12 to a display device 38 and/or printer 39. As mentioned above, the printer 39 may be a digital printer or the like. Further, in the merchant's arrangement, an automated reader/scanner 40 (shown in phantom lines since such is provided only at the merchant's side) may be included. Such readers/scanners are commercially available from many sources.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Thus, as shown in FIG. 4 in addition to the hardware and process environment described above, a different aspect of the invention includes a computer-implemented method of remotely printing media such as tickets, and for preventing counterfeiting, imitating, etc. of such tickets, as described above. As an example, this method may be implemented in the particular hardware environment discussed above.

Such a method may be implemented, for example, by operating the CPU 11 (FIG. 4), to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 11 and hardware above, to perform a method of performing a secure sale of electronic tickets.

This signal-bearing media may include, for example, a RAM contained within the CPU 11, as represented by the fast-access storage for example. Alternatively, the instructions may be contained in another signal-bearing media, such as a magnetic data storage diskette 400 (FIG. 4), directly or indirectly accessible by the CPU 11.

Whether contained in the diskette 400, the computer/CPU 11, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

Thus, with the method and structure of the invention described above, it is difficult, if not impossible, to create false tickets which could be mistaken for original tickets. Hence, counterfeiting will be deterred. Moreover, multiple issues of a legitimate ticket may be made without authorizing multiple use. Additionally, in the invention, optionally the ticket may be resold if some event (e.g., health, inconvenience, etc.) prevents its use by the original buyer.

While the overall methodology of the invention is described above, the invention can be embodied in any number of different types of systems and executed in any number of different ways, as would be known by one ordinarily skilled in the art. Thus, those skilled in the art will recognize that the invention can be practiced with modification within the spirit and scope of the appended claims.

For example, the above scenario for on-line transactions is easily modified for when a customer comes to the merchant location (e.g., box office of a stadium, arena, club, etc.), in which case the merchant can print the ticket, or send a printing instruction to the customer's electronic mail (e-mail) address. The customer is not necessarily the user and for example the invention can be used to generate hard-to-counterfeit gift certificates which are printed at either the merchant, the customer, or the beneficiary location.

For Internet commerce, the digital form of the gift certificate could be presented for payment instead of the printed version, in which case a central computer would check that the same gift certificate has not yet been used.

To be more specific, a “chèque FNAC” is a gift certificate that can be purchased to offer to some other person in a FNAC store in France. Different values of the “chèque FNAC” exist (e.g., FF 50, FF 100, FF 200,etc.).

With this “chèque FNAC”, the recipient can buy a record, a CD ROM, etc. in a FNAC store. Printing of these checks may be centralized, and the instruments are currently handled manually at some customer service counter in FNAC stores. Similar formulas exist in other stores, for example, of the Group Pinault Printemps Redoute. When paying, such instruments are received with the rest of the payment.

Using the present invention, a modification of the present “chèques FNAC”, could be purchased electronically (e.g., bought on the Internet), could be used for payment on the Internet, using the soft form of the certificate, and/or could be printed near the cash registers on the floor. Each of these aspects using the present invention extends the sale channels and incurs lower cost than the centralized, labor-intensive present method employed in such stores.

Tickets and Other Instruments Not Carrying the Identity of the User:

It is noted that the invention may or may not rely on obliging the user to reveal his/her identity, which may be considered by some as an invasion of privacy. This can be easily overcome by selling (or offering) non-duplicable cards carrying some alpha-numerical information different from one card to another (e.g., using smart card technology). In such a case, the information used in composing the ticket comprises some information read from the card. It is noted that, by using some zero-knowledge protocol or the like, a Smart card can be authenticated but cannot be duplicated, and the authentication may have no access to some of the information stored in the Smart card, while this information can be used during the usage of the Smart card, to generate other information. This property is what the present inventors consider to be the characterization of a smart card, for purposes of the present application. Accordingly, in the present disclosure, any electronic component with these properties and with some memory and/or some processing capabilities, will be called “a smart component” or “a Smart card”, even if it does not actually take any form resembling a “card”. A general reference to Smart card technology and applications can be found in “Smart Cards: A Guide to Building And Managing Smart Card Applications” by Henry Dreifus and J. Thomas Monk, John Wiley & Sons, 1998.

As an alternate to smart cards, or in conjunction with smart cards, the invention described in the above-mentioned U.S. patent application Ser. No. 09/___,___, filed on ______, commonly assigned and having IBM Docket No. YO999-129, can be used to produce non-reproducible cards or paper sheets which each carry its own unforgeable identification number.

In general, when using a ticket which carry such an unforgeable identification number, this number will be incorporated in the “digamas”. In such case, the name of the user is superfluous, except if needed for convenience and/or by regulation in some special instances.

Furthermore, in such a case, only one copy of each ticket or other value-bearing document will be printable in a manner which can be recognized as authorized, as follows from the combined facts that 1) the identification number of the medium carrying the print is incorporated in “digamas”, and 2) “digamas” is checked against “code” in the process of verification. Related art is also described in the invention described in the above-mentioned U.S. patent application Ser. No. 09/___,___, filed on ______, commonly assigned and having IBM Docket No. YO999-290.

Further, while the invention has been directed to printing “tickets”, the invention is easily suitable for printing other media which are the result or representative of a controlled transaction. In particular, especially in the version using an information-bearing medium where the print is being made, it could apply to stamps, currencies, and any other form of print which must be secure.

While the invention has been described in terms of preferred embodiments, those skilled in the art will recognize that the invention can be practiced with modification within the spirit and scope of the appended claims.

What is claimed is:

1. A method of guaranteeing authenticity of an object, comprising:
providing a sample of material obtainable only by at least one of chemical and physical processes such that the sample is random and not reproducible;
associating a number reproducibly to any said sample by using a specific reader; and
forming at least one coded version of said number, said at least one coded version being obtainable by a public key encryption, and said version being recorded into an area of said object.

2. The method according to claim 1, wherein said object comprises a smart card having a chip, and wherein said version is recorded into said chip of said smart card.

3. The method according to claim 2, further comprising:
wherein the number associated with said sample is recorded on said smart card.

4. The method according to claim 1, wherein said object comprises as ticket.

5. The method according to claim 1, wherein said object includes at least one of an identification of a characteristic to which said object relates and an identification of an authorized user of said object.

6. The method according to claim 1, wherein said object includes a bar-code presentation of predetermined information associated with the object, said predetermined information comprising at least one of a digital message and a code.

7. A method of preventing counterfeiting of an object, comprising:
providing a sample of material obtainable only by at least one of a chemical process and a physical process such that the sample is random and not reproducible;
associating a number reproducibly to any said sample using a specific, predetermined automated reading unit; and
associating at least one coded version of said number, said at least one version being obtainable by a public key encryption scheme, and being recorded into the object.

8. A method of preventing imitation of a smart card having a chip, comprising:
providing a sample of material obtainable only by at least one of a chemical process and a physical process such that the sample is random and not reproducible;
associating a number in a reproducible way to any said sample, using a specific reader;
associating at least one coded version of said number, said at least one version being obtainable by a public key encryption scheme, and being recorded into a chip of the smart card.

9. A method of remotely printing an object by a customer, comprising:
contacting, by a customer, a merchant of the object;
prompting, by the merchant, the customer for information related to said object;
composing, by said merchant, a digital message based on said information provided by said customer;
encrypting the digital message;
sending the encrypted digital message to said customer; and
selectively printing, by said customer, the digital message as said object.

10. The method according to claim 9, wherein said customer contacts said merchant directly over a communications link.

11. The method according to claim 10, wherein said communications link comprises one of the Internet and a telephone.

12. The method according to claim 9, wherein said customer contacts said merchant one of directly and through a payment agency.

13. The method according to claim 9, wherein said digital message comprises a symbolic representation of all information obtained about the customer and what action the object authorizes the customer to perform.

14. The method according to claim 9, wherein said merchant sends to the customer content information and a format of the object for printing, said digital message being sent electronically over a network.

15. The method according to claim 9, wherein said object comprises a printable medium, said method further comprising:
electronically linking together said customer for said object and said merchant of said object, said customer having a printer, and said merchant communicating to the customer a precise description of what must be printed to constitute said printed medium.

16. The method according to claim 15, further comprising:
hashing the digital message using a hash function H; and
choosing, by said merchant, a Private key/Public key pair (K, k).

17. The method according to claim 16, further comprising:
composing, by said merchant, a coded version of the hash of the digital message, wherein said coded version comprises a digital signature.

18. The method according to claim 17, wherein a bar-code is formed on said object, said bar code comprising a support of information which contains at least one of a representation of plain text and of the coded version.

19. The method according to claim 18, wherein said merchant forwards printing instructions to said customer,
said printing instructions including an ordered list of all data which are relevant to the constitution of the digital message, together with precise fonts and format instructions,
said printing instructions optionally including said code together with precise fonts and formats instructions to print said code.

20. The method according to claim 19, further comprising:
monitoring a usage of said object by said computer.

21. The method according to claim 20, further comprising:
reimbursing said customer if said object is determined not to have been used by said customer.

22. The method according to claim 21, further comprising providing a database to refuse instances of a code which indicates that the object has been reimbursed and/or transferred,
wherein each time said object is reimbursed, said code which was associated with the object at a time of sale is placed in a database of reimbursed objects, and wherein each time someone tries to use an object, the code associated with said object is read and said object is controlled if said code belongs to a list of codes to be refused.

23. The method according to claim 21, further comprising one of attaching a smart card to said object, and an unforgeable identification number to said digital message.

24. A system of preventing unauthorized duplication of a ticket, comprising:
means for providing a sample of material obtainable only by at least one of a chemical process and a physical process such that the sample is random and not reproducible;
means for associating a number in a reproducible way to any said sample, using a specific reader; and
means for associating one or a plurality of coded versions of said number, at least one version being obtainable by a public key encryption scheme, which version is recorded into the chip of the smart card.

25. A signal-bearing medium tangibly embodying a program of machine-readable instructions executable by a digital processing apparatus to perform a method for computer-implemented remote printing of an object by a customer, said method comprising:
contacting, by a customer, a merchant of the object;
prompting, by the merchant, the customer for information related to said object;
composing, by said merchant, a digital message based on said information provided by said customer;
encrypting the digital message;
sending the encrypted digital message to said customer; and
selectively printing, by said customer, the digital message as said object.
